(19) United States
(12) Patent Application Publication
(10) Pub. No.: US 2024/0269731 A1
(43) Pub. Date: Aug. 15, 2024

(54) SCREW-NUT BLANK FOR PRODUCING A SECURING NUT

(71) Applicant: SF HANDELS- UND BESITZGESELLSCHAFT MBH, Aldingen (DE)

(72) Inventor: Hartmut Flaig, Aldingen (DE)

(73) Assignee: SF HANDELS- UND BESITZGESELLSCHAFT MBH, Aldingen (DE)

(21) Appl. No.: 18/289,813

(22) PCT Filed: Apr. 28, 2022
(86) PCT No.: PCT/EP22/61412

§ 371 Date: Nov. 7, 2023

(30) Foreign Application Priority Data
May 11, 2021 (DE) 10 2021 112 274.0

(51) Int. Cl. B21K 1/70; F16B 39/38

(52) U.S. Cl. CPC B21K 1/707; F16B 39/38

(57) ABSTRACT

A securing nut and a screw-nut blank for producing the securing nut are disclosed. The securing nut (20) has a shaped collar (8) on an end surface (3), in one piece with the nut body (1), and an inner end surface (11) running concentrically relative to an internally threaded bore (9) of the nut body (1). Nut (20) is spaced axially (A) from the internally threaded bore (9) and has a securing internal thread (22) offset relative to an internal thread (23) of the internally threaded bore (9). The screw-nut blank (10) has an axially running annular collar (2) to form the shaped collar (8), and has a contour which remains constant in the circumferential direction. In the axial direction (A), the annular collar (2) has a cross-sectional shape which increases as the distance from the end surface (3) increases, in particular a conical cross-sectional shape. The ratio of a thickness (S1) of the annular collar (2) in the transition portion (6) with respect to the end surface (3) to a thickness (S2) of the annular collar (2) at a free end (7), which is used to form the inner end surface (11), is between 0.45 and 0.75, preferably between 0.5 and 0.7.

### BACKGROUND OF THE INVENTION

The present invention relates to screw-nut blanks for producing securing nuts.

A plurality of different securing nuts and their precursors in the form of screw-nut blanks are known from the prior art. Likewise, various methods for producing screw-nut blanks and for their further processing into securing nuts are known.

On the one hand, there is the approach of a multi-part production of the securing nut from different components or parts. This approach has the disadvantage that a complex and therefore cost-intensive production process must be carried out. In addition, the connection of the corresponding components or parts is a potential weak point or fatigue point of the securing nut.

In addition, there have been various approaches in the prior art for producing a one-piece securing nut, preferably from a one-piece screw-nut blank. For example, cold forming processes such as cold extrusion are used to produce the blanks or the securing screws preferably from a cylindrical metal starting material or cylindrical starting bodies in a multi-stage forming process.

Several of these solutions in the prior art can be traced back to the applicant. WO 2010/034324 A1 of the applicant provides a good overview of the prior art and in particular also of the different processes already known and the resulting securing nuts, which are produced from a one-piece blank and form a one-piece or one-part securing nut.

In these generic solutions, the basic approach was that at one stage of the screw-nut blank, a ring collar extending in the axial direction or protruding from the end surface in the axial direction was formed on an axial end surface; at a later stage of the process, said ring collar was reshaped, in particular axially, to form a shaped collar so that a tensioning or clamping effect can be exerted on a screw between an internally threaded hole of the nut body and an inner end surface of the shaped collar disposed concentrically with and at a distance from the internally threaded hole, which then causes the screw to be secured or the screw or a screw bolt to be self-secured.

For this purpose, a thread is formed in the shaped collar, which is axially spaced apart from the internally threaded hole by a slot or a recess, in particular on the inner end surface of the shaped collar, said thread having a certain offset from the female thread of the internally threaded hole of the nut body. As the screw is being screwed into the internally threaded hole and the female thread of the inner end surface of the shaped collar, the offset of the threads and the axially resilient or elastically deformable property of the shaped collar creates a spring or tensioning effect on the screw, enabling it to be secured.

Consequently, it is necessary that the shaped collar, in particular the inner end surface of the shaped collar, has a sufficient axial width or height to form a sufficiently long female thread or securing thread. However, in order to enable the reshaping of the ring collar into the shaped collar, it is in a certain way desirable if the thickness of the ring collar, which comprises the area which forms the inner end surface of the shaped collar at the end in an non-deformed or axially aligned state after the axial reshaping, is not chosen too large so that the reshaping can take place without causing excessive stress in the material, which may cause the material to corrugate after reshaping.

In a known securing nut and an associated method for its production, the ring collar was axially reshaped and simultaneously upset in order to meet these requirements, with the result that, on the one hand, the ring collar can have a relatively small wall thickness or thickness before its deformation, which allows it to be deformed, but, on the other hand, the inner end surface of the shaped collar produced from the ring collar, which has been reshaped during the reshaping and the radial upsetting, has a sufficient axial height or width to form or cut the securing thread. However, the radial upsetting of the formed shaped collar is disadvantageous since the upsetting is carried out in an insufficiently controlled manner and thus leads to a relatively inaccurate inner surface or inner end surface of the shaped collar.

In a further development of the prior art, various shapes of the ring collar were established which permit axial reshaping into a shaped collar without the need for radial upsetting. A major disadvantage of these securing nuts was that the shaped collar had recesses on an axially outer and/or axially inner outer surface, i.e., on an outer surface facing away from the nut body and/or on an outer surface facing the nut body. These recesses were necessary in order to reshape or redistribute the existing material of the ring collar during the axial reshaping of the ring collar, which leads to a reduction in cross section or diameter at least in the end areas of the ring collar.

However, said recesses or offset surface portions of the outer and/or inner surface of the shaped collar are disadvantageous for the securing effect of the shaped collar since the corresponding securing thread on the inner end surface of the shaped collar can only be formed incompletely, in particular in sections, and can only be formed with increased effort. In addition, the recesses are disadvantageous for the spring action of the shaped collar, which enables the securing effect.

Furthermore, a self-securing nut and a corresponding nut blank having an axially protruding ring collar which is reshaped into a shaped collar by reshaping and which is provided with a securing thread is known from U.S. Pat. No. 2,289,828 A. The ring collar is provided with a widening profile/cross section.

U.S. Pat. No. 3,289,724 A teaches a self-securing nut having a shaped collar produced from a ring collar. The shaped collar has no thread cut into it, but merely an engagement surface engaging a corresponding thread.

Based on this prior art, the object of the present invention is to propose screw-nut blanks and securing nuts which enable an improved securing effect.

### SUMMARY OF THE INVENTION

With regard to the screw-nut blank for producing a securing nut, this object is attained with the features disclosed herein.

Advantageous embodiments are the subject matter of the description and the dependent claims.

The invention provides a screw-nut blank for producing a securing nut, the securing nut having a shaped collar formed in one piece with the screw body on an end surface of the screw body, the shaped collar having an inner end surface concentric with an internally threaded hole of the screw body and having a distance from the internally threaded hole in the axial direction And having a securing female thread offset from a female thread of the internally threaded hole, the screw-nut blank having an axially extending ring collar serving to form the shaped collar by reshaping, and the ring collar having a constant contour in the circumferential direction And a cross-sectional shape which increases in the axial direction As the distance from the end surface increases, in particular a conical cross-sectional shape, wherein the ratio of a thickness of the ring collar in the area of transition toward the end surface to a thickness of the ring collar at a free end serving to form the inner end surface is between 0.45 and 0.75, preferably between 0.5 and 0.7.

A screw-nut blank having a conical cross section which widens with increasing distance from the end surface of the nut body is known from the prior-art publication mentioned above, the shape of the ring collar shown there, in particular in FIG. 1b, and described in the document not being capable of being reshaped into a shaped collar without the outer surface of the shaped collar formed having recesses or offset surfaces which, as described above, are detrimental to the securing effect of the securing nut.

However, it has turned out in a surprising manner that the shape according to the invention or the selection according to the invention of the ratio of the thickness of the ring collar otherwise constant in the circumferential direction enables both the radially upset-free reshaping, in particular axial reshaping, into a shaped collar while also enabling reshaping into a shaped collar without the outer surface and/or the inner surface of the shaped collar having depressions, offset surfaces or recesses. Rather, the cross section according to the invention with the ratio of the thickness of the ring collar between 0.45 and 0.75, preferably between 0.5 and 0.7, with regard to the thickness of the ring collar in the area of transition toward the end surface to the thickness of the ring collar at a free end, enables the outer surface and/or inner surface formed to form or have a plane, in particular recess-free or offset-free contour or surface across the entire circumference after the reshaping of the ring collar.

The securing nut according to the invention and the screw-nut blank are preferably a one-piece metal body, which is particularly advantageously treated or produced by cold forming processes.

By means of the invention, it can be achieved in an unforeseeable enhancement of the prior art that a sufficiently wide or high inner end surface of the shaped collar is formed without radial upsetting while the inner end surface allows the securing female thread to be formed or introduced in a simple manner through the adjacent, plane, in particular recess-free outer and/or inner surface(s) of the shaped collar, with the result that the securing female thread can be formed easily and, moreover, the shaped collar has an advantageous deformation or spring property which, in conjunction with the thread offset between the internally threaded hole and the inner end surface, brings about the securing effect of the securing screw. Similarly, the geometry of the ring collar according to the invention enables a securing nut with particularly good securing properties since the shaped collar formed from the ring collar can be provided plane or without recesses and thus has optimized spring or clamping behavior.

According to a first advantageous embodiment of the screw-nut blank, the ratio of the thickness of the ring collar in the area of transition toward the end surface to a thickness of the ring collar at a free end serving to form the inner end surface may be between 0.1 per millimeter in length to 0.15 per millimeter in length between the area of transition and the end surface with respect to the length of the ring collar. The length is to be defined or determined by the free end of the ring collar on one side and by the area of a minimum thickness of the ring collar on the other side. In other words, this means that there is a first area in the area of transition in which a reduction of the thickness of the ring collar takes place in the axial direction based on the cross-sectional shape or the conical cross section of the ring collar. This portion is followed by a portion in which the thickness of the screw-nut blank increases gradually or abruptly. The axial position of the lowest thickness of the ring collar before a gradual or abrupt increase in the thickness of the screw-nut blank is to be used to define or measure the length of the ring collar.

The ratio between the change in thickness of the conical cross section of the ring collar to the length of the ring collar prior to deformation, in particular an axial reshaping supports in a particularly advantageous manner that the axial reshaping of the ring collar is made possible, while at the same time maintaining or forming outer surfaces and/or inner surfaces of the formed shaped collar that are plane, in particular recess-free, across the entire circumference.

According to another particularly advantageous embodiment of the screw-nut blank, the thickness of the ring collar at the free end is 0.8 to 1.5 times the pitch of a securing thread to be formed on the ring collar reshaped into the shaped collar.

In a particularly advantageous manner, this not only creates the prerequisite for an advantageous formation of the shaped collar but also ensures an advantageous effect of a later shaped collar for securing or for forming a securing thread. After all, the securing effect of the securing thread cannot be ensured unless the securing thread can form a sufficient thread portion.

According to another particularly preferred embodiment of the screw-nut blank, in the radial direction, the ring collar is disposed between two shoulder portions of the end surface of the nut body, the shoulder portions sloping down on either side. This means that the ring collar, does not merge into or end in a plane or horizontal surface of the nut body in the radial direction, in particular radially inward, but rather that the area of the end surface of the nut body disposed radially inward in relation to the ring collar also forms a shoulder portion sloping radially inward.

Of course, a shoulder portion formed radially outside and a shoulder portion of the end surface of the nut body formed radially inside with respect to the ring collar may have a different inclination or slope and/or have different lengths. Particularly preferably, the radially inner shoulder portion can be less steep but have a greater length than the radially outer shoulder portion.

Advantageously, the ring collar may have a hollow cylindrical end portion adjacent to and/or starting from the free end, said end portion preferably comprising an axial dimension of up to one half of a securing thread to be formed later on the ring collar reshaped into the shaped collar.

This advantageously improves the stability of the ring collar, which in turn ensures that undesirable buckling of the ring collar/shaped collar does not occur when the ring collar is reshaped into the shaped collar of the securing nut.

With regard to the securing nut (not part of the scope of the invention) with a shaped collar disposed on an end surface of the screw nut and having an inner end surface concentric with an internally threaded hole of the nut body, said inner end surface having a distance from the internally threaded hole in the axial direction And having a securing female thread offset from a female thread of the internally threaded hole and preferably being made of a screw-nut blank according to the type described above, the shaped collar may have, at least adjacent to the inner end surface, a plane, in particular recess-free, outer surface and/or inner surface across the entire circumference.

As explained above, the plane outer surface and/or inner surface across the entire circumference of the shaped collar is an essential prerequisite for an effective securing effect of the shaped collar when screwing in a screw or a screw bolt.

According to a first advantageous embodiment of the securing nut, the inner end surface may be formed by a reorientation of the free end of the ring collar, said reorientation being radially compression-free in particular in the end position. Thus the securing nut according to the invention is equipped with a shaped collar which has both plane outer and/or inner surfaces across the entire circumference of the shaped collar and is also free of compression in the area of the inner end surface, i.e., radially free of compression, with the result that the shaped collar formed in this manner, in particular the inner end surface of the shaped collar, is overall suitable for forming the securing female thread and, moreover, the shaped collar has optimum deformation properties or spring properties which determine or at least influence the securing effect of the securing nut.

According to a further particularly preferred embodiment of the securing nut, the distance between the shaped collar and the end surface may be formed by an inner groove which is defined by an inner shoulder portion of the end surface sloping radially inward and a preferably radially plane or horizontal lower edge of the shaped collar. The configuration of the inner groove with a plane upper side formed by a plane lower edge of the shaped collar and a radially inwardly sloping lower side formed by the sloping shoulder or the sloping shoulder portion of the end surface also has surprisingly advantageous effects on the securing nut.

### BRIEF DESCRIPTION OF THE DRAWINGS

The present invention and advantageous embodiments are explained below with reference to highly schematized drawings.

FIGS. 1a, 1b: a screw-nut blank according to the invention in a third process stage for producing a securing nut;

FIGS. 2a, 2b: a securing nut (not part of the scope of the invention) produced from the screw-nut blank shown in FIG. 1.

### DETAILED DESCRIPTION

In the following description, the term screw-nut blank is used as long as the ring collar provided for forming the shaped collar is still formed in the axial direction or essentially runs in the axial direction. The term securing nut is used when the ring collar has been or is reshaped into the shaped collar. Of course, this classification is not binding. After all, on the one hand, the formation of female threads may still be intended for the actual completion of the securing nut even after the ring collar has been reshaped into the shaped collar, which means the finished securing nut or the complete processing to produce a securing nut is not completed or finished until later. On the other hand, a transition from the blank to the nut could also be defined or determined at an earlier stage, in principle.

Unless otherwise described, the screw-nut blank and the securing nut are one-piece metallic bodies and the associated method steps are preferably cold forming processes using appropriate tools and generally known flow forming or cold forming processes.

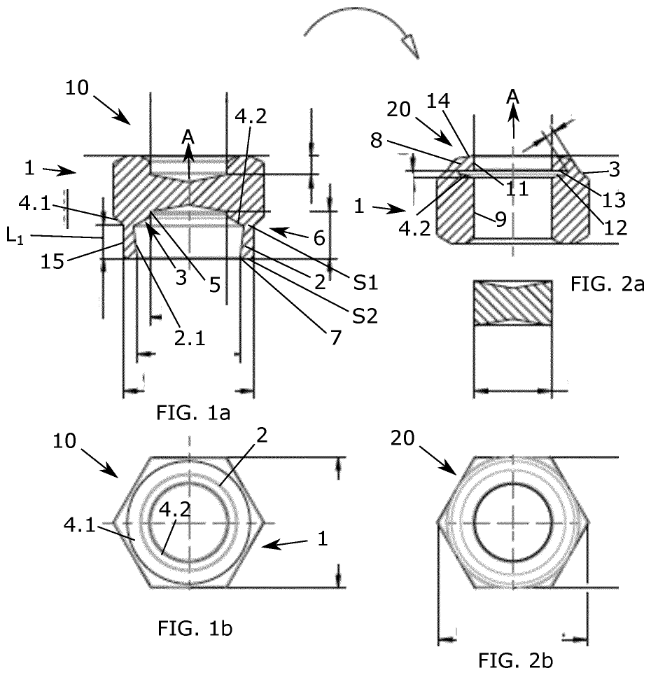

FIG. 1a shows a section through a screw-nut blank. FIG. 1b shows a top view of the screw-nut blank. It can already be seen that a ring collar 2 which extends axially in the axial direction A is integrally formed on an end surface 3 of a nut body 1. The end surface 3 of the nut body 1 already has two shoulder portions 4.1, 4.2 adjacent to the ring collar 2 on the inside and outside, i.e., radially on the inside and radially on the outside. The radially inner shoulder or the radially inner shoulder portion 4.2 is defined by an edge 5 which essentially already defines the diameter of an internally threaded hole to be formed later in the nut body 1.

After initial machining and forming steps, which belong to the state of the art and are known to the average person skilled in the art, the screw-nut blank is cold-formed in a forming tool, the result of which is shown in FIGS. 1a and 1b. The cross section of FIG. 1a shows that the ring collar 2 has a constant contour in the circumferential direction, which has an increasing or widening cross-sectional shape in the axial direction, in particular a conical cross-sectional shape, with increasing distance from the end surface 3. The cross-sectional shape according to the invention is designed in such a manner that the thickness S1 of the ring collar 2 in the area of transition 6 toward the end surface 3 to a thickness S2 of the ring collar 2 at a free end 7 of the ring collar 2 serving to form the inner end surface of the shaped collar of the securing nut is between 0.45 and 0.75, preferably between 0.5 and 0.7.

The outer edge or the outer surface 15 of the ring collar 2 extends in the axial direction and forms a cylindrical contour. In the radial direction, the ring collar 2 is still formed or disposed between two outwardly and inwardly sloping shoulder portions 4.1 and 4.2 of the end surface 3.

In FIG. 1, in particular in FIG. 1a, it can also be seen that there is still a solid portion in the nut body 1 of the screw-nut blank 10, said solid portion also ensuring the stability of the screw-nut blank 10 but still having to be removed or eliminated in a later method step in order to form the internally threaded hole.

FIG. 2a and FIG. 2b show a sectional view and a top view of a securing nut 20 according to the invention. In the processing or the corresponding method step following the stage of FIG. 1, the ring collar 2 has been reshaped into the shaped collar 8, this reshaping having essentially been effected or carried out by an axial reshaping of the free end 7 of the ring collar 2. At the same time, in the same method step, although not at exactly identical times, a perforation or punch hole in the nut body 1 was produced, an internally threaded hole 9 being formed in the process. The securing nut 20 thus has a shaped collar 8 formed integrally on the end surface 3 of the screw nut or of the nut body 1, with an inner end surface 11 extending concentrically with the internally threaded hole 9 of the nut body 1. The inner end surface 11 was formed from the free end 7 of the ring collar 2 essentially by reorientation and otherwise without upsetting. The inner end surface 11 of the shaped collar 8 has a distance from the internally threaded hole 9 in the axial direction A. In addition, a securing female thread not yet shown in FIG. 4 and possibly not yet formed can be formed on the inner end surface 11, said securing female thread, which is also not yet shown in FIG. 2 and possibly not yet incorporated, being offset from a female thread of the internally threaded hole 9. The distance of the inner end surface 11 from the upper edge or an upper end of the internally threaded hole 9 is achieved or formed by an inner groove 12, which is defined by an radially inwardly sloping inner shoulder portion 4.2 of the end surface 3 and a preferably radially plane lower edge or inner surface 13 of the shaped collar 8.

As can be seen from the securing nut 20 of FIG. 2, the inner surface 13 adjacent to the inner end surface 11 and the outer surface 14 adjacent to the inner end surface 11 are plane, in particular free of recesses or offsets, across the entire circumference, which benefits the deformation or spring effect of the shaped collar 8 and thus improves the securing effect of the securing nut.

Up to now, such a plane inner surface 13 and/or outer surface 14 has not been possible in the context of generic cold forming processes of one-piece screw-nut blanks 10 or securing nuts unless the method step involved a radially acting upsetting of the free end 7 or the inner end surface in addition to the axial reshaping of the shaped collar 8 into the ring collar 2.

### REFERENCE SIGNS

1 nut body
2 ring collar
2.1 inner surface of the ring collar
3 end surface
4.1 shoulder portion
4.2 shoulder portion
5 edge
6 area of transition
7 free end of the ring collar
8 shaped collar
9 internally threaded hole
10 screw-nut blank
11 inner end surface
12 inner groove
13 inner surface
14 outer surface of the shaped collar
15 outer surface of the ring collar
20 securing nut
A axial direction
H axial dimension
L₁ length
S1, S2 thickness

1. A screw-nut blank for producing a securing nut (20), the securing nut (20) having a shaped collar (8) formed in one piece with the nut body (1) on an end surface (3) of the screw nut, the shaped collar (8) having an inner end surface (11) concentric with an internally threaded hole (9) of the nut body (1), the shaped collar (8) having a distance from the internally threaded hole (9) in the axial direction (A) and having a securing female thread (22) offset from a female thread (23) of the internally threaded hole (9), the screw-nut blank (10) having an axially extending ring collar (2) serving to form the shaped collar (8) by reshaping, and the ring collar (2) having a constant contour in the circumferential direction and a cross-sectional shape which increases in the axial direction (A) as the distance from the end surface (3) increases,
wherein
the ratio of a thickness (S1) of the ring collar (2) in the area of transition (6) toward the end surface (3) to a thickness (S2) of the ring collar (2) at a free end (7) serving to form the inner end surface (11) is between 0.45 and 0.75.

2. The screw-nut blank according to claim 1,
wherein
the ratio of the thickness (S1, S2) of the ring collar (2) in the area of transition (6) toward the end surface (3) to a thickness (S1, S2) of the ring collar (2) at a free end (7) serving to form the inner end surface (11) is between 0.1 per millimeter in length to 0.15 per millimeter in length with respect to the length (L₁) of the ring collar (2) between the area of transition (6) and the end surface (3).

3. The screw-nut blank according to claim 1,
wherein
the thickness (S1, S2) of the ring collar (2) at the free end (7) is 0.8 to 1.5 times the pitch of a securing female thread (22) to be formed on the ring collar (2) reshaped into the shaped collar (8).

4. The screw-nut blank according to claim 1,
wherein
in the radial direction, the ring collar (2) is disposed between two shoulder portions (4.1, 4.2) of the end surface (3) which slope to both sides.

5. The screw-nut blank according to claim 1,
wherein
the ring collar (2) has a hollow cylindrical end portion (42) adjacent to and/or extending from the free end (7).

6. (canceled)

7. (canceled)

8. (canceled)

9. The screw-nut blank according to claim 1, wherein the cross-sectional shape is a conical cross-sectional shape.

10. The screw-nut blank according to claim 1, wherein the ratio is between 0.5 and 0.7.

11. The screw-nut blank according to claim 5, wherein the end portion (42) has an axial dimension (H) of up to half a securing thread to be formed later on the ring collar (2) reshaped into the shaped collar.
